(19) United States
(12) Patent Application Publication
(10) Pub. No.: US 2007/0199513 A1
(43) Pub. Date: Aug. 30, 2007

(54) Diagnostic litter for animals

(75) Inventors: Pierluigi Caretti, Arese (IT); Stefania Tornelli, Pizzighettone (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), BRUSSELS (BE)

(21) Appl. No.: 11/547,833

(22) PCT Filed: Apr. 21, 2005
(86) PCT No.: PCT/EP05/51776

§ 371 Date: Feb. 1, 2007

(30) Foreign Application Priority Data
Apr. 22, 2004 (FR) 04 04273

(51) Int. Cl. A01K 1/015

(52) U.S. Cl. 119/171

(57) ABSTRACT

Use of an animal litter having a whiteness value greater than 90 %, for observing the colour of the animal's urine by observing the modification of the coulour of the litter after its contact with the urine.

The invention relates to the diagnosis of animal diseases by means of the examination of their urine. It relates more particularly to animal litter allowing this diagnosis.

It is known that various animal diseases manifest themselves through a modification of the colour of their urine. Thus, for example, a cat with jaundice will have urine of intermediate colour between yellow and green, blue urine indicates a urinary tract infection while red-brown urine may indicate heavy metal poisoning.

To use this correlation between certain diseases and certain particular colours for the diagnosis of these diseases, it is however necessary to collect a quantity of urine from the animal. This operation is difficult or even impossible for some animals.

The invention aims to allow easy detection of certain animal diseases that modify the nature of the urine by avoiding the difficulties of its collection.

Consequently, the invention relates to the use of an animal litter such that at least 90% by weight of the particles that make it up have a whiteness value greater than 90%, for observing the colour of the animal's urine by observing the modification of the colour of the litter after its contact with the urine.

At least 90%, advantageously 95%, preferably 99% of the particles which make up the litter have a whiteness value greater than 90%. The remainder of the particles may have a lower whiteness value, or may even have a different colour.

The whiteness value of greater than 90% of at least 90% of the particles of the litter allows a simple and rapid observation of the colour of the urine. The whiteness value is measured by the Hunter method. Indeed, when the animal has urinated in the litter, the latter is no longer white but has, by virtue of the initial whiteness value of most of its particles, a colour that is very similar to that of the animal's urine.

The presence of a small quantity, at most 10%, advantageously 5%, preferably 1% by weight of particles having a whiteness of less than 90% does not adversely affect this similarity. These particles may be for example additives, intended in particular for the detection of specific diseases.

However, in one advantageous embodiment of the use according to the invention, the litter is such that 100% by weight of the particles which make it up have a whiteness value greater than 90%. In this embodiment, the observation of the colour of the litter is even easier.

It is observed that when the whiteness value is not greater than 90%, the colour of the litter after contact with the urine may have a colour that is very different from that of the urine, which makes the detection, from the colour of the litter, of a defect of the colour of the urine itself impossible. The normal colour of the urine of the healthy animal being close to light yellow, any other colour taken by the litter after contact with the urine, such as brown, green or even blue or red, makes it possible to suspect the presence of a disease in the animal. The detection of the possibility of disease in the animal may be made at home and without collecting urine.

In a recommended variant of the use according to the invention, the whiteness value is greater than 92%, preferably 94%.

In the use according to the invention, the litter preferably comprises at least 50% of calcium sulphate.

It is recommended that it comprises at least 10% of calcium carbonate.

In an advantageous variant, it comprises at least 10% of magnesium hydroxide.

In the use according to the invention, the litter may be advantageously obtained from the purification of sodium chloride solutions intended for the production of sodium carbonate by the aqueous ammonia process. These solutions, called brine, contain sulphates and carbonates. To separate them, lime is injected into the brine, which causes crystallization of the calcium sulphates and carbonates. The impurities are then separated from the brine and then dried at a temperature of between 175 and 225° C. They are then in the form of particles.

Some animal diseases modify the composition of the animal's urine but do not directly affect their colour. In this case, in a preferred embodiment of the litter according to the invention, it comprises an additive intended for the detection of specific diseases by modifying its colour upon contact with the animal's urine. For example, this additive may be copper sulphate, for the detection of a large quantity of proteins in the urine, a sign of renal insufficiency. Indeed, copper sulphate has a light blue colour. In an alkaline medium, the Cu⁺⁺ ions bind to the proteins, producing a purple coloured complex The change in the colour of the particles of the additive from blue to purple therefore makes it possible to suspect a renal insufficiency in the animal.

The invention also relates to a method for the diagnosis of animal diseases applied to the urine of the said animals, according to which the animal urinates in a litter such that at least 90% by weight of the particles which make it up have a whiteness value greater than 90% and the colour of the litter is then compared with a urine colour table associated with various diseases.

In an advantageous variant of this method, the litter comprises at least one additive intended for the detection of specific diseases by modification of its colour upon contact with the animal's urine.

The invention also relates to a diagnostic litter product for animals comprising
(a) a litter such that at least 90% by weight of the particles which make it up have a whiteness value greater than 90%, as described above
(b) a urine colour table associated with various diseases.

The urine colour table may for example be printed on a packaging containing the litter. It may also be provided separately, inside or attached to the outside of the packaging.

The following example serves to illustrate the invention.

### EXAMPLE

A quantity of lime that makes it possible to precipitate most of the sulphates and carbonates contained in the brine intended for the production of sodium carbonate by the aqueous ammonia process is injected into the brine. The impurities precipitated were separated from the brine. They were dried at 200° C. in a rotary oven. The granular material obtained was then sieved in order to extract therefrom the particles having a diameter of between 1.5 and 5 mm. The extracted particles appeared to have a whiteness value (index) of 96%, measured by the HUNTER method on a COLOR READER CR-14 type measuring instrument marketed by MINOLTA.

The composition of the particles was analyzed and the results presented in Table 1 were obtained.

| | |
|---|---|
| CaSO₄ | 64.6% |
| CaCO₃ | 14.3% |
| Mg(OH)₂ | 15.2% |
| NaCl | 3.8% |
| H₂O | 2.1% |

About one kg of this material was collected and used as litter for a cat. After the cat had urinated, the litter had a blue colour. A presumption that the cat had urinary tract infection was deduced therefrom.

1. A method for observing the color of an animal's urine, comprising providing an animal litter such that at least 90% by weight of the particles that make it up have a whiteness value greater than 90%, and observing the color of the animal's urine by observing the modification of the color of the litter after its contact with the urine.

2. The method according to claim 1, in which the whiteness value is greater than 92%.

3. The method according to claim 2, in which the whiteness value is greater than 94%.

4. The method according to claim 1, in which the litter further comprises at least 50% of calcium sulphate.

5. The method according to claim 1, in which the litter further comprises at least 10% of calcium carbonate.

6. The method according to claim 1, in which the litter further comprises at least 10% of magnesium hydroxide.

7. The method according to claim 1, in which the litter further comprises at least one additive intended for the detection of specific diseases by modifying its color upon contact with the animal's urine.

8. The method according to claim 1, in which the litter is composed of particles having a mean diameter ranging from 1.5 to 5 mm.

9. A method for the diagnosis of animal diseases applied to the urine of the said animals, comprising having the animal urinate in a litter such that at least 90% by weight of the particles that make it up have a whiteness value greater than 90% and comparing the color of the litter with a urine color table associated with various diseases.

10. The method according to claim 9, in which the litter further comprises at least one additive intended for the detection of specific diseases by modification of its color upon contact with the animal's urine.

11. A diagnostic litter product comprising
(a) an animal litter such that at least 90% by weight of the particles that make it up have a whiteness value greater than 90%, and
(b) a urine color table.
